(19) United States
(12) Patent Application Publication
(10) Pub. No.: US 2012/0242453 A1
(43) Pub. Date: Sep. 27, 2012

(54) ENERGY MANAGEMENT IN RFID SYSTEMS WITH LONG TERM ACTIVE SENSING

(75) Inventors: Eladio Clemente Delgado, Burnt Hills, NY (US); Timothy Lee Johnson, Niskayuna, NY (US); Richard Joseph Gawrelski, Amsterdam, NY (US)

(73) Assignee: LOCKHEED MARTIN CORPORATION, Bethesda, MD (US)

(21) Appl. No.: 11/616,174

(22) Filed: Dec. 26, 2006

(51) Int. Cl. G06K 7/01

(52) U.S. Cl. 340/10.1

(57) ABSTRACT

The inventive RFID Environmental Monitoring System (RFID_EMS) includes an RFID-based Environmental Monitor and Energy Management Logic for reducing energy consumption in active RFID tags used for long-term active sensing of storage and transit conditions of shipping containers. The RFID-based Environmental Monitor consists of an active RFID tag containing an RF transponder, microcontroller, sensors and associated interface circuitry. The Energy Management Logic provides hardware and software which work together, and consists of executable software or microcontroller logic that monitors and regulates energy use by an RFID tag and associated sensors, and may control the state of specialized peripheral circuits on the tag. By reading the RFID_EMS tag, the invention enables the determination of the condition of precision equipment prior to use, including equipment that requires high readiness after long periods of transit and/or storage.

### BACKGROUND OF THE INVENTION

1. Field of the Invention

This invention relates to the field of radio frequency identification (RFID) and, more particularly, to energy management in active radio frequency identification systems with long term active sensing of storage and transit conditions.

2. Discussion of the Prior Art

Precision equipment manufacturers, shippers, distributors, insurers, and end purchasers all are potential users of RFID systems. Such equipment normally includes “in transit” or “storage” specifications that must be performed if the equipment is to operate correctly when removed from its transit or storage container. RFID systems can be used to establish whether such conditions have been violated during shipping or storage, and hence can be used to evaluate warranty, shipping damage, or insurance claims. These systems can also be used to identify and reduce risks that occur during shipping and storage so that these processes can be improved.

RFID systems are also often used for keeping track of large numbers of parts, either identical or of various types, that are separately shipped and stored in a depot, warehouse or other storage location. Under such conditions, it is very difficult, expensive, and time-consuming to locate, identify and manually inspect individual containers without RFID equipment.

RFID systems with long term “active” sensing make periodic or stimulus-driven measurements of shipping conditions such as shock, temperature, pressure, hydrocarbon vapors, and humidity. A container able to intelligently monitor its state and raise an alert without intervention from a central system, incorporating RFID and sensing technologies, is disclosed, for example, in WO 2004/102327. While this patent illustrates RFID, it discusses tracking the container as opposed to its contents.

Unlike “passive” RFID applications, “active” RFID applications require the active management of energy that is necessary to measure, store, and maintain sensed data values over extended periods of time, typically from one to twenty-five years. The RFID system, including both RFID reader and RFID tag, may be used only infrequently during this time, such as sporadically at the end user's discretion. In the extreme case, the RFID may be dormant until the contents of the container are placed into use after a prolonged period of storage. Thus, the time at which the RFID is activated may be quite distant from the time at which damage to the container or its contents actually occurred. In such long-term sensing applications, it is crucial that the RFID system have very high reliability, integrity, and survivability, so that in those rare cases where damage has occurred, the tag will have survived the damage, and an accurate reading of its contents can be obtained.

The primary limitation on tag reliability and integrity is loss of power. Even though tag data may be preserved up to the time of loss of power, the tag will fail to record subsequent measurements, and may not be readable by an RFID reader when it is required to operate. Standard power sources such as batteries carry an initial fixed energy level, so that the energy remaining in a tag is simply the initial energy level less the energy used (e.g., time-integral of power required at each point in time). Thus; the total energy consumption from tag initialization to the time at which a reading occurs will determine the remaining energy, and whether loss of power will occur.

In some cases, sources of energy may be applied during the tag lifetime, that is batteries can be recharged or replaced. One technique for maintaining power in tags and readers is to provide “depot power” to tags when storage containers are in a warehouse area that has power. A variant on this approach has been used in automotive and other remote control applications, where either the reader or the tag has a rechargeable power source. By contrast, military shipping container applications generally do not offer any local power source for either the reader or the tag for extended periods of time.

Another alternative involves different tags using car battery variants placed inside containers. However, this introduces potentially dangerous and contaminating chemicals (e.g. lead, acid) into the container environment. Further, these types of tags must still be periodically recharged. Overall care must be taken that the time and expense of these techniques do not defeat the original purpose of the system.

Still other alternatives include RFID tags that operate on low-frequencies in short ranges; these are capable of some self-powered responses. In addition, to satisfy the longer-range requirements, there are RFID tags that use higher frequencies and are self-powered.

Recently, very low power microcontrollers that support multiple energy saving modes have become available. These microcontrollers are designed for general purpose applications for use in low power small appliances such as digital wristwatches and cell phones. As an example, U.S. Pat. Nos. 6,255,962 and 6,469,639 discuss using low power data acquisition circuits with RFID and shock sensing in a shipping container setting. These patents disclose apparatus which monitors Micro-Electronic Mechanical Sensing (MEMS) and has two basic modes of operation, a normal mode and a real time mode. In the normal mode, the sensors are monitored at prearranged times or in response to external events, while in the real time mode, the sensors can respond to external commands. While the patents disclose that the apparatus includes a low power data acquisition circuit, they provide no mention of power saving techniques.

Reducing energy use of RFID tags by replacing large numbers of batteries in or on containers in a depot, for instance, is not acceptable to users. There is a need to extend the RFID tag operating life by reducing the power or energy consumption of the RFID system.

### BRIEF SUMMARY OF THE INVENTION

The present invention advantageously provides active sensor-based RFID tags to solve the above problems in the prior art. A novel hardware-software co-design strategy, based on physical fundamentals, minimizes energy use. Strategic fundamentals such as low voltage, processor speed, and sample rate management, are linked to the macroscopic physics of power use in electro-mechanical devices of the RFID category.

The inventive RFID Environmental Monitoring System (RFID_EMS) includes an RFID-based Environmental Monitor and Energy Management Logic for reducing energy consumption in active Radio-Frequency Identification (RFID) “tags” used for long-term active sensing of storage and transit conditions of shipping containers of precision equipment. The RFID-based Environmental Monitor consists of an active RFID tag containing an RF transponder, microcontroller, sensors and associated interface circuitry. The Energy Management Logic provides hardware and software which work together, and consists of executable software or microcontroller logic that monitors and regulates energy use by an RFID tag and associated sensors, and may control the state of specialized peripheral circuits on the tag. By reading the RFID_EMS tag, the invention enables the determination of the condition of precision equipment prior to use, including equipment that requires high readiness after long periods of transit and/or storage.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is an overview of the major system elements of an exemplary embodiment of the invention;

FIG. 1A is a schematic diagram of system elements of an exemplary embodiment of the invention;

FIG. 2 is a schematic diagram of the primary elements of a tag; and

FIG. 3 is the state machine logic of an exemplary energy management logic.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

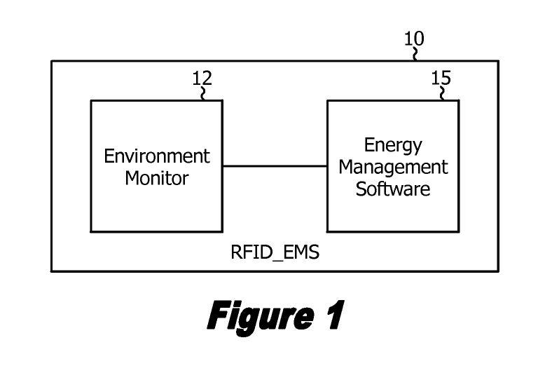

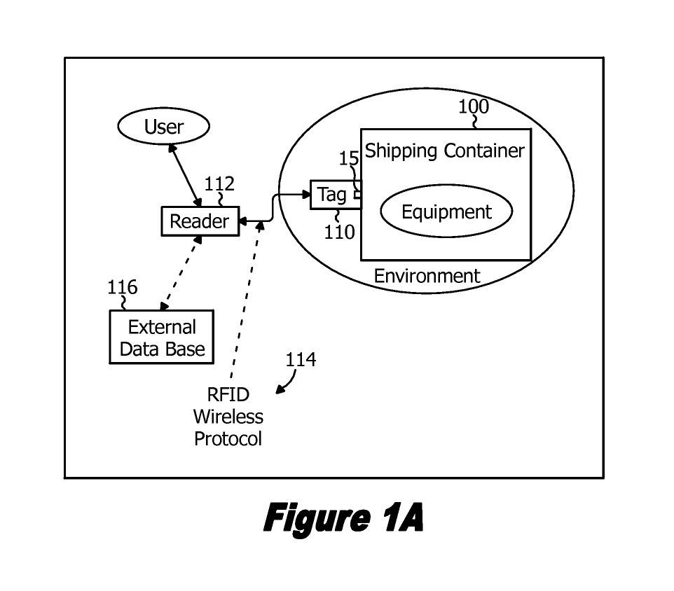

The invention as shown schematically in FIG. 1 is an RFID Environmental Monitoring System (RFID_EMS) 10 comprising an RFID-based environmental monitor 12 and energy management logic or software 15. In this RFID_EMS, “active” RFID tags combine hardware which uses minimal power with software which encourages minimal power usage to obtain a low-power system. The RFID_EMS 10 includes co-designed hardware and software on an RFID_EMS tag 110. The energy management logic or software 15 is embedded on a low-power microcontroller 220 that, through its input/output ports, monitors and/or regulates power use by itself, and by peripheral sensing circuits on the tag.

The primary benefit of this invention is to allow the condition of precision equipment that requires high readiness after long periods of transit and/or storage to be determined prior to use, by reading the RFID_EMS tag. This reading is accomplished via a separate, wireless “RFID_EMS Reader”. Although quantities such as estimated energy use that may be tracked on the tag, can be viewed on the reader, the invention disclosed herein is mainly implemented on the tag hardware and software.

FIG. 1A illustrates a simple implementation of this system. A shipping container 100 has an RFID_EMS tag 110 attached. An RFID_EMS reader 112 can access the tag using a wireless protocol 114. In addition to displaying information, the reader stores the information in a database 116.

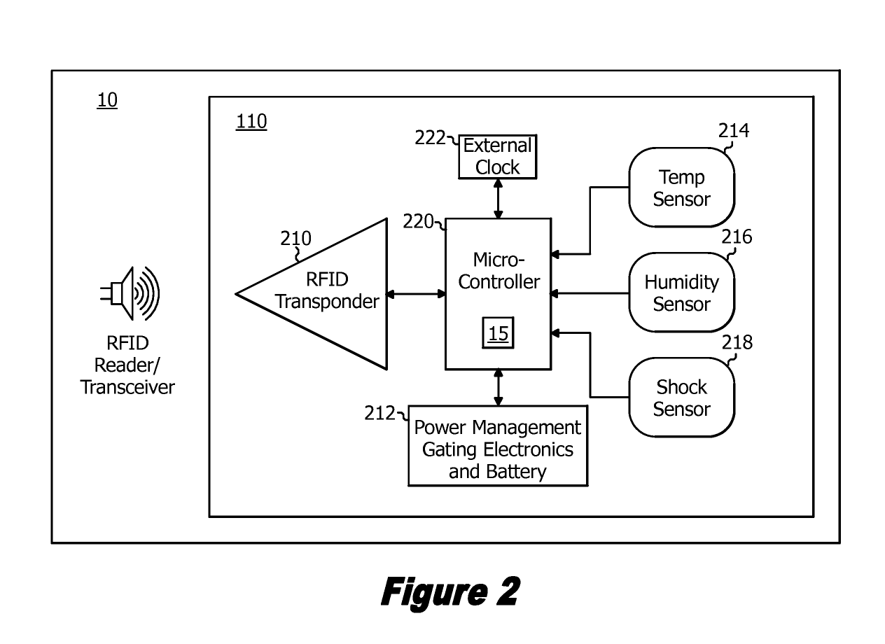

The elements of an active tag 110 of an embodiment of the inventive system are illustrated in FIG. 2. The elements or hardware features include a transponder 210, a microcontroller 220, a battery 212, an external clock 222, and three sensors 214, 216, 218. An internal or controller clock (not shown) residing on the microprocessor can be used instead of or in addition to the external clock. The battery 212 can be a low voltage battery, for example 3.0V. The number of sensors is not limited to three but can be as few as one and as many as appropriate. They can be self-triggering sensors that use external or self-generated power. Further, the sensors can be powered using a method that only consumes power during a stimulus, to trigger interrupts that wake the processor from a “sleep” state. In addition, sensors with sensor power gating can be used, allowing the sensors to be shut off when not needed.

In addition to the above hardware, energy harvesting from RF field can be used to reduce net power consumption by the RFID transmitter or transponder 210 in the tag. For example, trickle charging mode using energy harvesting from RF field to boost available energy in the battery storage system can be employed.

The microcontroller can be a variable-clock-rate microcontroller 220. At least some of the sensors can be low-power, rapid-response sensors that reduce “on” current and stabilization time; these sensors can be smaller than traditional sensors. The system can also include power-on reset circuitry that reduces power consumption during start-up. Other features on the microprocessor can include On-chip Enhanced Flash program, and EEPROM data memory that allows retention of critical information obtained while the microprocessor is in “sleep” state or in power off mode.

The energy management logic or software 15 of the RFID_EMS resides on the microcontroller. The software enables energy conservation in a variety of ways. For example, the software can enable internal or external clock shifting, wherein the controller clock can be shifted to low frequencies, allowing the microprocessor to remain in “sleep” mode most of the time, with minimal clock power consumption.

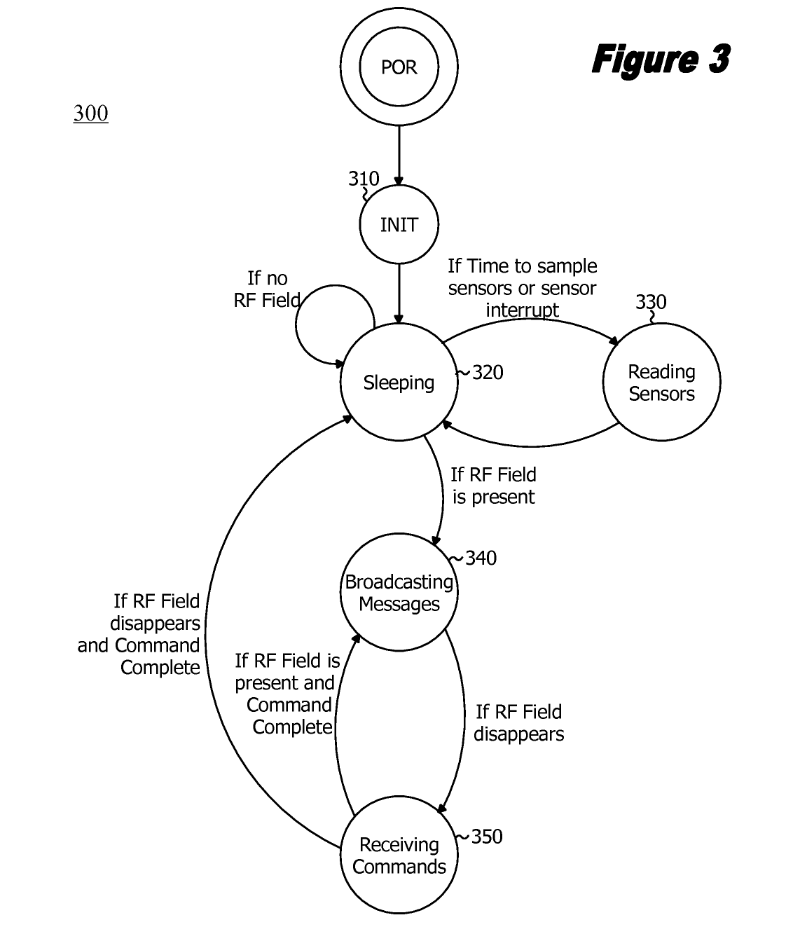

Further, the software 15 can include variable-rate state-machine based logic, triggered by interrupts and by external crystal oscillator signals to regulate the processor energy consumption according to the task that it is performing. The processor is placed into a very low power “sleep” state when it has no tasks to perform; alternatively, the processor is placed in its lowest clock speed. The processor is placed in an “idle” or low clock speed state when it needs to perform slow tasks (e.g., low baud rate serial interfaces), and the processor operates at higher clock speeds when it must perform fast-response-time tasks such as interrupt processing from external sensors or higher bandwidth communications. In each state, selected additional hardware features are activated and/or de-activated to minimize energy consumption. FIG. 3 illustrates a simplified state machine.

Included in the exemplary state machine are states of INIT or initialization 310, Sleeping 320, Reading Sensors 330, Broadcasting Messages 340 and Receiving Commands 350. The state machine operates as follows. From the INIT state, the machine enters the Sleeping 320 state. The machine remains in Sleeping state until either an RF field is detected, or it is time to sample a sensor, or a sensor interrupt is detected. Upon detection of a sensor interrupt, the machine enters Reading Sensors state 320. Upon completion of the Reading Sensors state, the machine returns to the Sleeping state. If an RF field is detected, the machine enters the Broadcasting Messages state 340. If the RF field disappears, the machine enters the Receiving Commands state 350. If the RF field disappears and the command is complete, the machine returns to the Sleeping state 320; if the RF field remains present and the command is complete, the machine enters the Broadcasting Messages state 340. The machine remains in the Sleep state unless the presence of an RF field interrupts it, a timer interrupt wakes it to take a periodic measurement, or an interrupt producing sensor requires attention. The state machine 300 operates at a hybrid rate, depending on whether synchronous or asynchronous tasks are being performed. For instance, scheduled sampling of “slow” variables may occur synchronously, based on a predetermined schedule, while communications with the reader may occur asynchronously, driven by events transmitted from the RFID reader. The processor clock will perform synchronous, multi-rate and asynchronous operation; however, maintenance of synchronous schedules requires that clock time be tracked and maintained in a consistent set of time-units.

The energy management software may also track or estimate its own cumulative energy usage from a specified time, such as “last clock reset” or “last battery change-out”. For example, when the time spent in each energy management state is known, along with the average power consumption rate in that state, then the total energy consumed during the time spent in that state can be estimated, and the total energy use from “last reset” can be calculated and reported via the RFID reader. Finally, cumulative energy usage, or usage rate, i.e. power consumption, may be used to adapt the tag parameters (e.g., sensor schedule timing, trigger thresholds) in order to prolong battery life.

The energy management approach described herein is capable of exploiting the low power modes of the microprocessor and various sensors, but this approach is not restricted exclusively to low power microcontrollers.

While the present invention has been described in particular embodiments, it should be appreciated that the present invention should not be construed as limited by such embodiments, but rather construed according to the below claims.

1. An RFID environmental monitoring system comprising:
an RFID reader; and
an active RFID tag receiving data from and transmitting data to said RFID reader, said RFID tag comprising:
an RF transponder;
a microcontroller having energy management software and an internal clock;
a low-voltage battery; and
a plurality of sensors, wherein:
the energy management software regulates energy consumption of the RF transponder, the microcontroller and the plurality of sensors and calculates a cumulative historical energy consumption of at least the RF transponder, the microcontroller and the plurality of sensors for a period of time.

2. The system according to claim 1, wherein the energy management software places the microcontroller into one of a very low clock speed state for waiting for interrupts or tasks, a low clock speed state for responding to interrupts or for performing slow-response-time tasks, and a high clock speed state for performing fast-response-time tasks.

3. The system according to claim 1, wherein at least one of the plurality of sensors further comprises means for sensor power gating.

4. The system according to claim 1, wherein the RF transponder comprises means for energy harvesting from an RF field.

5. The system according to claim 4, wherein said means for energy harvesting comprises a trickle charging mode for boosting energy in the battery.

6. The system according to claim 1, wherein at least one of the plurality of sensors is a low-power rapid response sensor.

7. The system according to claim 1, wherein at least one of the plurality of sensors is a self-triggering sensor.

8. The system according to claim 7, wherein at least one of the plurality of sensors is a low-power rapid response sensor.

9. The system according to claim 1, further comprising a variable external clock which is adjustable based upon the cumulative historical energy consumption calculated by the energy management software.

10. The system according to claim 1, wherein the RFID tag further comprises power-on reset circuitry.

11. The system according to claim 1, wherein the energy management software further comprises on-chip enhanced flash program.

12. The system according to claim 2, wherein the RFID tag further comprises EEPROM data memory for storing the data while the microcontroller is in the very low clock speed state.

13. The system according to claim 1, wherein the microcontroller is a variable clock rate microcontroller.

14. The system according to claim 1, wherein RFID tag parameters are controlled based upon the calculated cumulative historical energy consumption.

15. The system according to claim 1, wherein the data transmitted to said RFID reader is stored in a database.

16. The system according to claim 1, wherein the RFID tag further comprises specialized peripheral circuits, said circuits controlled by the energy management software.

17. A computer readable storage device having computer readable program code for operating on a computer for performing energy management of an RFID environmental monitoring system, said computer readable program code comprising the steps of:
transmitting data between an RFID reader and an RFID tag, and
regulating energy consumption of an RF transponder, a microcontroller, and a plurality of sensors and calculating a cumulative historical energy consumption of at least the RF transponder, the microcontroller and the plurality of sensors for a period of time.

18. The computer readable program code of claim 17, wherein regulating energy consumption of the microcontroller further comprises placing the microcontroller into one of a very low clock speed state for waiting for interrupts or tasks, a low clock speed state for responding to interrupts or for performing slow-response-time tasks, and a high clock speed state for performing fast-response-time tasks.

19. The computer readable program, code of claim 17, wherein at least one of the plurality of sensors comprises means for sensor power gating.

20. The computer readable program code of claim 17, wherein the RF transponder comprises means for energy harvesting from an RF field.

21. The computer readable program code of claim 20, wherein said means for energy harvesting comprises a trickle charging mode for boosting energy in a battery.

22. The computer readable program code of claim 17, wherein at least one of the plurality of sensors is a low-power rapid response sensor.

23. The computer readable program code of claim 17, wherein at least one of the plurality of sensors is a self-triggering sensor.

24. The computer readable program code of claim 17 further comprising a variable external clock which is adjustable based upon the cumulative historical energy consumption calculated by the energy management software.

25. The computer readable program code of claim 17, further comprising the step of: controlling tag parameters based upon the calculated cumulative historical energy consumption.

26. A method for monitoring an RFID environmental monitoring system, said method comprising:
transmitting data between an RFID reader and an RFID tag, and
regulating energy consumption of an RF transponder, a microcontroller, and a plurality of sensors and calculating a cumulative historical energy consumption of at least the RF transponder, the microcontroller and the plurality of sensors for a period of time.

27. The system according to claim 1, wherein said period of time is an entire period between clock resets.

28. The system according to claim 1, wherein said period of time begins when a battery is changed and is reset each time a battery is changed.

29. The system according to claim 1, wherein said calculated cumulative historical energy consumption is transmitted to the RFID reader.

30. The system according to claim 14, wherein said tag parameter is a sensor schedule timing.

31. The system according to claim 14, wherein said tag parameter is a trigger threshold for a corresponding sensor of said plurality of sensors.

32. The system according to claim 1, wherein said active RFID tag operates in a plurality of management states and wherein said calculating is based upon a time spent in each of the plurality of management states and an average power consumed in a corresponding each of the plurality of management states.
